(19) United States
(12) Patent Application Publication
(10) Pub. No.: US 2018/0054093 A1
(43) Pub. Date: Feb. 22, 2018

(54) ELECTRIC GENERATOR THAT GENERATES ELECTRICAL ENERGY BY MAGNETIC INDUCTION

(71) Applicant: Arnold Yoonho Lee, Woodland Hills, CA (US)

(72) Inventor: Arnold Yoonho Lee, Woodland Hills, CA (US)

(21) Appl. No.: 15/239,599

(22) Filed: Aug. 17, 2016

(51) Int. Cl. H02K 1/18; H02K 1/27; H02K 5/16; H02K 5/18; H02K 7/116; H02K 9/06

(52) U.S. Cl. CPC H02K 1/187; H02K 1/27; H02K 5/16; H02K 1/185; H02K 7/116; H02K 9/06; H02K 5/18

(57) ABSTRACT

The present invention relates to an electric generator that uses electric coils and magnets to induce electrical energy by magnetic induction. The present invention utilizes more coils and magnets then the prior art in similar size enclosure so as to maximize the amount of electrical energy generated. Air flow is effectively induced by the present invention to dissipate excess heat created by the added coils and magnets. In addition, the present invention utilizes heat fins strategically placed to maintain the system with n a predetermined operating temperature range.

### BACKGROUND OF THE INVENTION

### Field of the Invention

The present invention relates generally to a field of energy production by harnessing the forces of induction. More specifically, the invention relates to an electric generator that uses electric coils and magnets to induce electrical energy by magnetic induction.

### Description Of The Prior Art

The demand for energy has increased dramatically in recent years partly due to the increase in the world's population. Furthermore, fossil fuels, such as oil and natural gas, are increasingly becoming higher in cost and their availability is limited. Additionally, efforts to generate energy by nuclear power have been tempered by environmental and safety concerns. In the face of these challenges and growing demand, energy generation has become the focus of much research. Energy generation through magnetic induction has become desirable because it can be converted to practical use without environmental contamination or chemical pollution concerns.

Electric generators are rotating devices that can be used for a variety of purposes. Using an electric generator provides a renewable source of electricity which does not require fossil fuels or excrete carbon byproducts.

Traditional electric generators are horizontal axis electric generators, wherein a horizontally supported shaft rotates and the rotation can be transformed in to electrical energy. Other generators have a vertical axis, wherein a rotating shaft is mounted vertically on a vertically supported axis. A problem with vertical axis electric generator is that the shaft has a tall and large surface area that create inefficiencies due to drag.

Whether an electric generator operates on a vertical or horizontal axis, the concept is still the same. The rotation of a shaft can be used to induce electrical energy using magnets that rotate around stationary coils, as described in detail in this application.

In recent years, various electricity generating utilities promoted schemes to decentralize the commercial electricity grid. Utilities have promoted the generation of energy by the use of decentralized devices located on buildings or on land or in yards belonging to small commercial companies or even individuals. In many areas of the country where grid connection is available, electrical utilities offer “net metering”, such that both the utility and the end user can generate electricity. Therefore, as the interest in co-generation of electrical energy grows, there will be a need for better, more efficient renewable-energy electricity generating devices.

The electric generator of the present invention maximizes the generation of electrical energy within the same size footprint as the prior art. The electric generator of the present invention is novel and nonobvious primarily due to the efficient arrangement of coils and magnets that jointly induce electrical energy from the rotation of a shaft. The inventor of this application believes that the most relevant prior art is U.S. Pat. No. 8,796,878 (hereinafter referred to as “the '878 Patent”), which discloses a vertical axis electric generator having stationary coils attached to the center stat nary shaft and magnets attached to the housing or shell that is rotated by the vertical foils. Thus, the magnets rotate around the stationary coils. This rotation induces the generation of electrical energy by magnetic induction. The electrical energy is then transferred to batteries or coupled to the power grid.

As described in detail in this application, the electric generator of the present invention incorporates substantially more coils and magnets within substantially the same footprint size as the '878 Patent to induce substantially more electrical energy.

in addition, unlike the prior art, the electric generator of the present invention also provides a cooling system driven by self-induced air flow combined with the use of heat fins configured to maintain the temperature within the system within a predetermined range.

Thus, based on the increase demand for electrical energy, a heretofore unaddressed need exists for an electric generator that can maximize the induction of electrical energy without overheating the system.

### SUMMARY OF THE INVENTION

Accordingly, the present invention has been made in view of the above-mentioned disadvantages occurring in the prior art. The present invention is an electric generator that efficiently induces electrical energy that can then be transferred to batteries or the power grid.

It is therefore a primary objective of the present invention to maximize the amount of electrical energy generated through magnetic induction by utilizing substantially more coils and magnets than the prior art.

A further objective of the present invention is to utilize coils on opposite sides of each magnet so as to maximize the induction of electrical energy.

A yet further objective of the present invention is to attach the magnets to a cylinder that is rotated around the coils that are stationary.

A yet further objective of the present invention is to induce air flow as part of its cooling system to dissipate excess heat and maintain the system within a predetermined temperature range.

A yet further objective of the present invention is to utilize heat fins as part of its cooling system to dissipate excess heat and maintain the system within a predetermined temperature range.

A yet further objective of the present invention is to include a robust housing that provides structural protection against sudden impact.

A yet further objective of the present invention is to include a base that allows the present invention to be installed either horizontally or vertically depending on the specific application.

The above objects and other features of the present invention, as well as the structure and operation of various embodiments of the present invention, are described in detail below and with reference to the accompanying drawings.

### DESCRIPTION OF THE DRAWINGS

The accompanying drawings which are incorporated by reference herein and form part of the specification, illustrate various embodiments of the present invention and, together with the description, further serve the explain the principles of the invention and to enable a person skilled in the pertinent art to make and use the invention. In the drawings, like reference numbers indicate identical or functional similar elements. A more complete appreciation of the invention and many of the attendant advantages thereof will be readily obtained as the same becomes better understood by reference to the following detailed description when considered in connection with the accompanying drawings, wherein:

FIG. 1 is a perspective view of the electric generator of the present invention in its assembled state as it would be used to induce electrical energy.

FIG. 2 is an exploded view of the electric generator of the present invention.

FIG. 3 is a sectional view of the electric generator of the present invention.

FIG. 4 is a perspective view of the rotor assembly of the electric generator of the present invention.

FIG. 5 is a sectional view of the rotor assembly of the electric generator of the present invention.

FIGS. 6a and 6b is a perspective view of the coil shaft of the electric generator of the present invention.

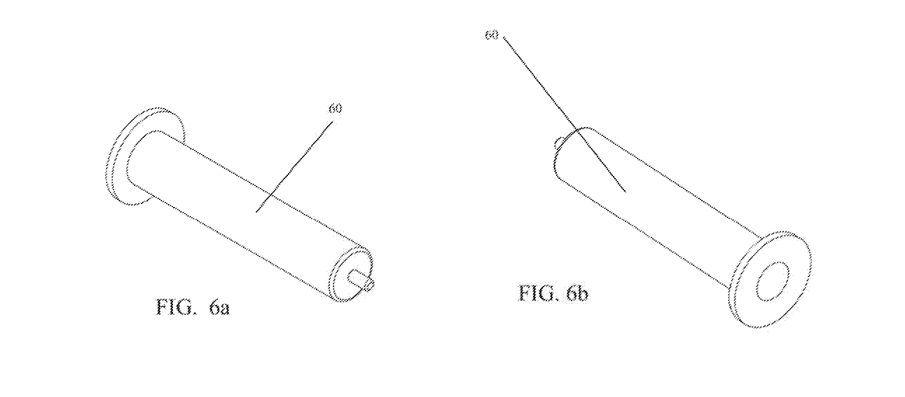

FIGS. 7a and 7b is a perspective view of the rear end caps of the electric generator of the present invention.

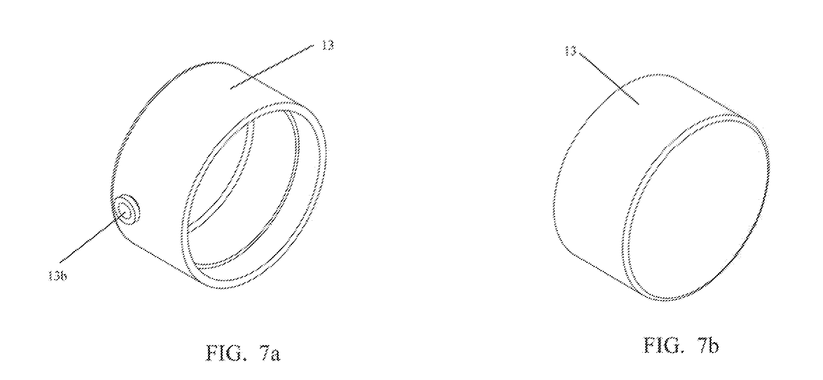

FIGS. 8a and 8b is a perspective view of the shell of the electric generator of the present invention.

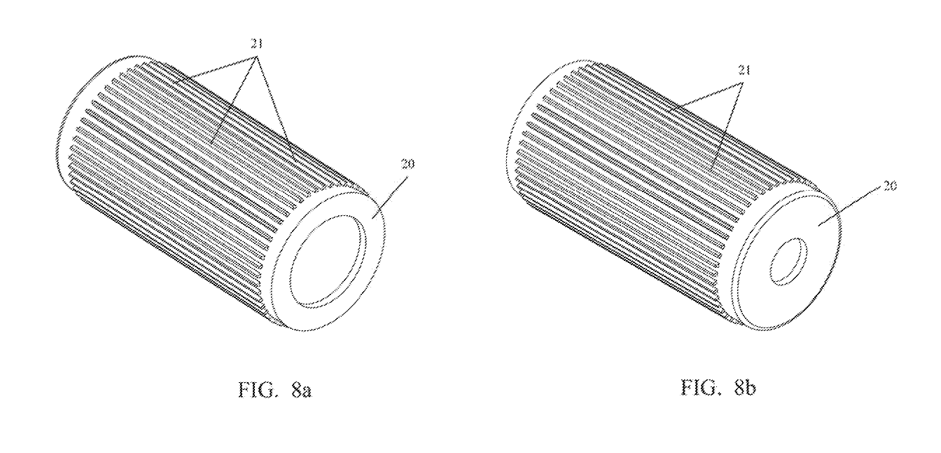

FIGS. 9a and 9b is a perspective view of the housing of the electric generator of the present invention.

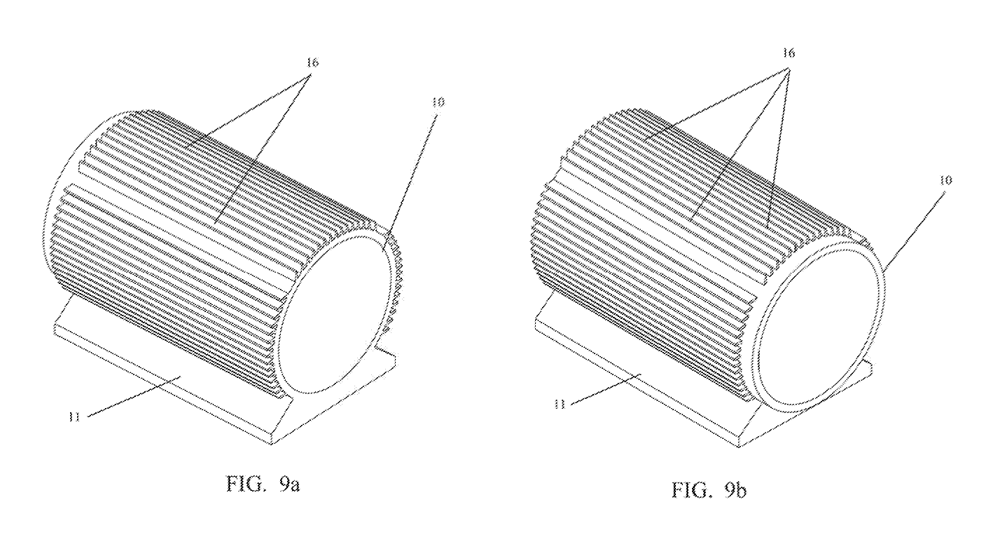

FIGS. 10a and 10b is a perspective view of the front end caps of the electric generator of the present invention.

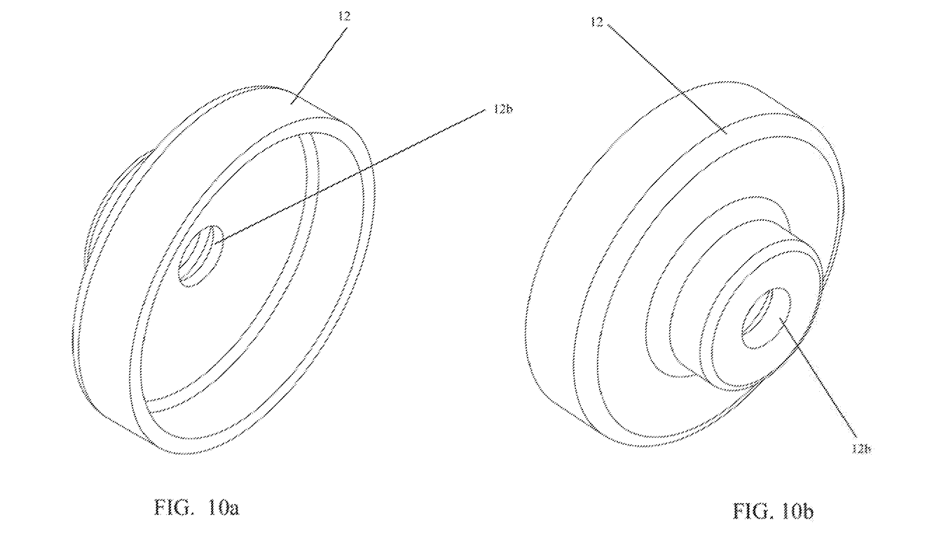

### DETAILED DESCRIPTION OF THE PREFERRED EMBODIMENTS

Reference will not be made to the drawings in which various elements of the present invention will be given numerical designations and in which the invention will be discussed so as to enable one skilled in the art to make and use the invention.

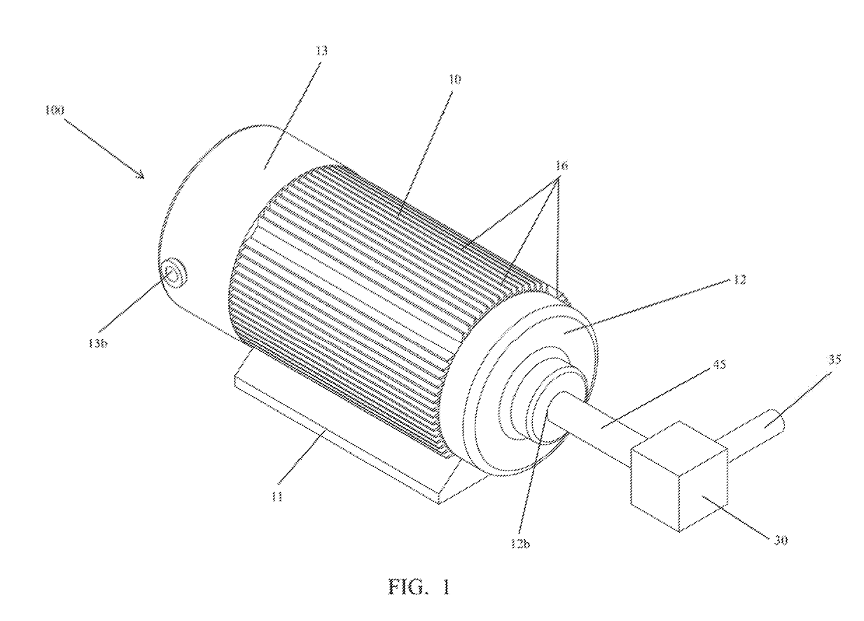

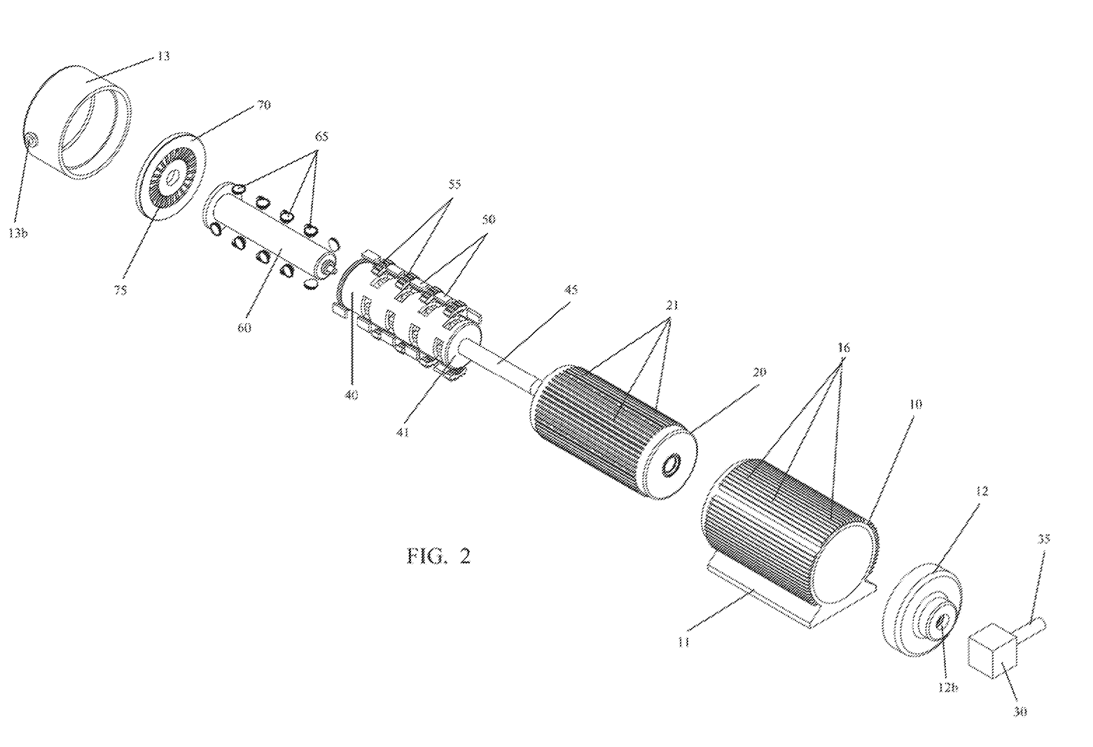

The electric generator 100 of the present invention comprises a housing 10, a base 11, a front end cap 12, a rear end. cap 13, a shell 20, a plurality of inner coils 25, a gear box 30, a generator shaft 35, a rotor cylinder 40, a rotor shaft 45, a plurality of magnets 50, a plurality of fan blades 55, a coil shaft 60, a plurality of outer coils 65, and a bearing plate 70. FIG. 1 shows a perspective view of the electric generator 100 of the present invention in its assembled state as it would be used to generate electrical energy. FIG. 2 shows an exploded view of the electric generator 100 of the present invention to depict in greater detail the various components that comprise the electric generator 100.

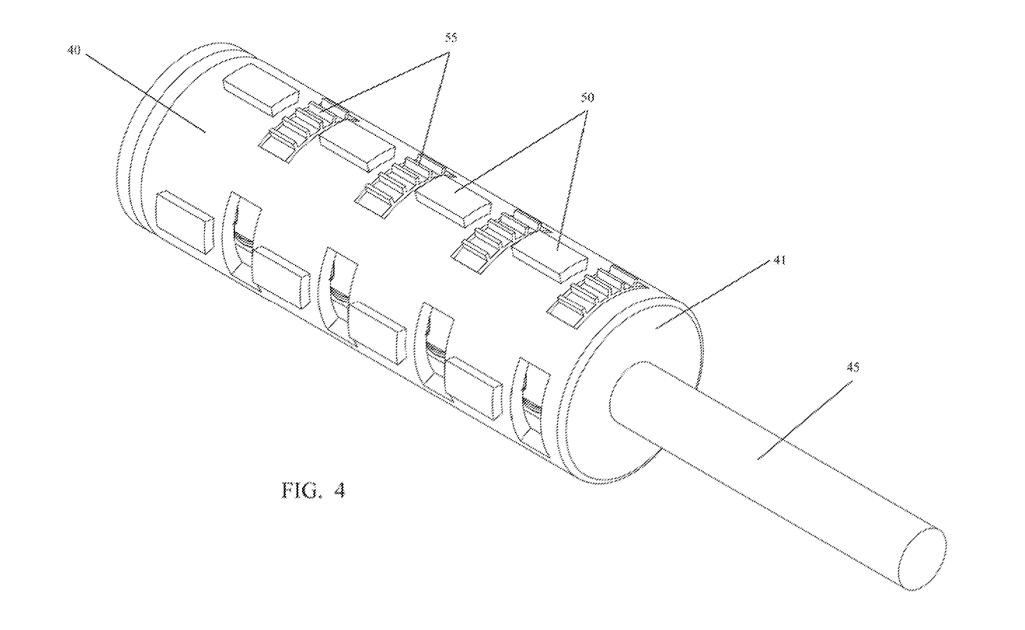

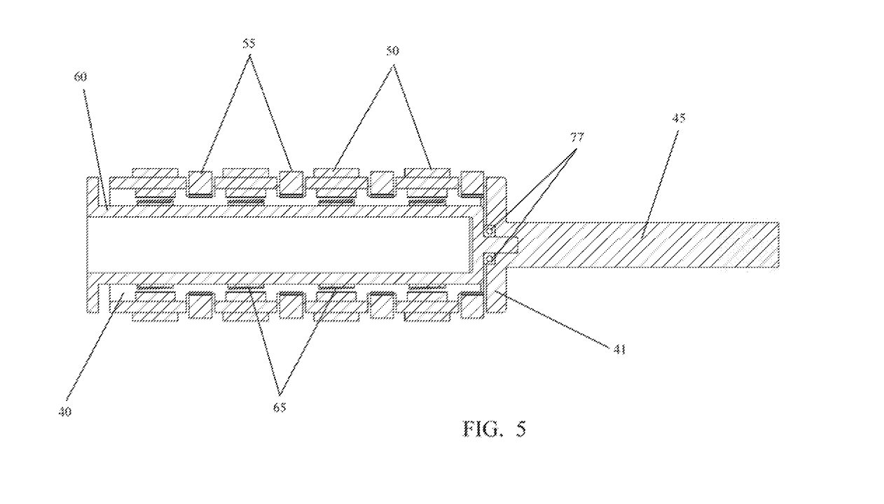

FIGS. 4 and 5 show a perspective view and a sectional view of the rotor assembly in which the rear end of the rotor shaft 45 is centrally attached to a plate 41 of the rotor cylinder 40. Further, a sidewall 42 is attached to the perimeter of the plate 41 and extends so as to define a hollow cylinder. Finally, attached to the sidewall 42 are a plurality of magnets 50 and a plurality of fan blades 55. As shown in FIG. 5, each magnet 60 has a positive polarity side and a negative polarity side. The magnets 50 are attached to the sidewall 42 in an alternating polarity configuration. In other words, the magnets 50 are attached to the rotor cylinder 40 in alternating positive polarity side and negative polarity side.

Thereafter, the rotor shaft 45 is connected to the gear box 30 as show in FIG. 1. In addition, the generator shaft 35 is attached to the gear box 30. The gear ratio of the gear box 30 is configured so that for every rotation of the generator shaft 35, the rotor shaft 45 is rotated at least twice. Furthermore, the generator shaft 35 is caused to rotate by a mechanical force, for example, it can be attached to the rotating wheel of an automobile or the rotating blades of a wind turbine. In essence, the mechanical force rotates the generator shaft 35 on its axis. The gear box 30 then transmits the rotating power of the generator shaft 35 to rotate the rotor shaft 45 at a higher rate and at a perpendicular angle relative to the generator shaft 35. The rotation of the rotor shaft 45 then induces the rotation of the rotor cylinder 40.

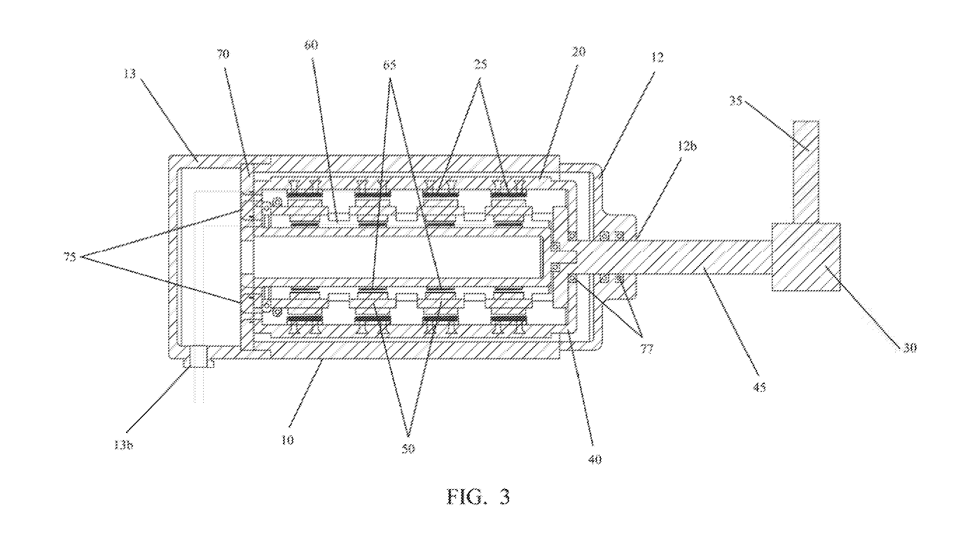

As shown in FIG. 3, the coil shaft 60 is rigidly attached to the bearing plate 70. Furthermore, the plurality of inner coils 25 are attached along the coil shaft 60, as shown in FIG. 5. The plurality of inner coils 25 are stationary along the coil shaft 60, thus, the inner coils are stators of the electric generator 100 of the present invention. The coil shaft 60 is hollow so that wires from the inner coils 25 are routed through the hollow section of the coil shaft 60.

Then the rotor cylinder 40 is positioned so that it encloses the coil shaft 60, as shown in FIG. 3. In fact, the magnets 50 are attached to the rotor cylinder 40 such that each magnet 50 is in alignment with an inner coil 25 on one side and an outer coil 65 on the other side. Furthermore, the rotor cylinder rests against a plurality of bearings 75 placed on the bearing plate 70, as shown in FIG. 3. The bearings 75 reduce any frictional forces that would resist the rotation o the rotor cylinder 40.

As shown in FIG. 3, the shell 20 is a hollow cylindrical shell that is rigidly attached to the bearing plate 70 and encloses the coil shaft 60 and the rotor cylinder 40. Furthermore, the plurality of outer coils 65 are rigidly attached to the interior face 21 of the shell 20, as shown in FIG. 3. In the preferred embodiment of the present invention, the outer coils 65 are positioned so as to be in alignment with the inner coils 25.

As shown in FIGS. 1 and 3, the rear end cap 13 is then placed over the bearing plate 70 and is coupled with the housing 10 that is placed over the shell 20. The front end cap 12 is then coupled to the other end of the housing 10 with the rotor shaft 45 passing through the hole 12b is said front end cap 12.

Once the electric generator 100 of the present invention is assembled as shown in FIG. 1, the generator shaft 35 is rotated and the gear box 30 induces at least two rotations of the rotor shaft 45 for every rotation of the generator shaft 35. Rotation of the rotor shaft 45 facilitates the rotation of the rotor cylinder 40. The rotation of the rotor cylinder 40 causes the rotation of the magnets 50 around the coil shaft 60. Thus, the rotation of the rotor cylinder 40 induces the rotation of the magnets 50 around the inner coils 25 and the outer coils 65. The rotational motion of the magnets 50 induces electrical energy in the inner coils 25 and outer coils 65 by magnetic induction. The electrical energy is then transferred through wires attached to the inner coils 25 and outer coils 65. The wires attached to the inner coils 25 and outer coils 65 are routed rearward into the rear end cap 13 and out through a wire hole 13b in the rear end cap 13. The wires can then he connected to batteries or coupled to the power grid. The electrical energy can then be transferred to batteries or coupled to the power grid through said wires.

Furthermore, as electrical energy is induced, the temperature inside the shell 20 may have a tendency to increase. However, the fan blades 55 attached to the sidewall 42 of the rotor cylinder 40 are configured to induce air flow inside the shell 20 as the rotor cylinder 40 rotates. The air flow allows for cooling within the shell 20 so that the temperature therewithin is maintained within a predetermined range.

In addition, a plurality of heat fins 21 are attached to the outer surface of the shell 20. The heat fins 21 allow for the dissipation of heat out of the shell 20. The heat fins 21 are configured with sufficient surface area to allow heat from within the shell 20 to dissipate by induction and convection at a predetermined rate. Even further, a plurality of venting boles are added throughout the shell 20 and the rotor cylinder 40 to allow the air to flow and circulate within the housing 10. Then another set of venting boles are location in the housing 10 to allow the air to flow and circulate within the electric generator 100 of the present invention.

Additionally, the preferred embodiment of the present invention has another set of fins 16 attached to the outer surface of the housing 10. The fins 16 are configured to induce some heat dissipation and to provide structural support and protection against sudden impact. Thus, the housing 10 is configured to provide robust protection to the electric generator 100 of the present invention.

Even more, the preferred embodiment of the present invention has a base 11 that allows the electric generator 100 of the present invention to provide stability as it is installed horizontally. However, a similar base can be added to the rear end of the electric generator 100 of the present invention to allow for a vertical installation.

Finally, the preferred embodiment of the present invention has a plurality of ball bearings 77 around the rotor cylinder 40 and the rotor shaft 45 to facilitate their rotation as described above, as shown in FIG. 3.

The electric generator 100 of the present invention is configured to maximize the induction of electrical energy as compared to the prior art, in particular, U.S. Pat. No. 8,796,878 (hereinafter referred to as “the '878 Patent”). The '878 Patent teaches an electric generator with magnets that revolve around one set of coils to induce electrical energy. However, the electric generator 100 of the present invention in a novel and non-obvious manner incorporates the rotor cylinder 40 so that the magnets 50 would be rotated around two sets of coils, the inner coils 25 and the outer coils 65, so as to induce substantially more electrical energy within the same structural footprint as the prior art. In addition, unlike the prior art, the electric generator 100 of the present invention incorporates a novel and non-obvious cooling system.

It is understood that the described embodiments of the present invention are illustrative only, and that modifications thereof may occur to those skilled in the art. Accordingly, this invention is not to be regarded as limited to the embodiments disclosed, but to be limited only as defined by the appended claims herein.

What is claimed is:

1. An electric generator that comprises:
a housing attached to a base;
a front end cap;
a rear end cap;
a plurality of outer coils attached to a coil shaft that is centrally attached to said rear end cap;
a plurality of inner coils attached to a shell that is attached to said rear end cap and concentric to said coil shaft;
a plurality of magnets attached to a rotor cylinder that has a rotor shaft and that is rotatably placed between said shell and said coil shaft;
wherein said housing is attached to said rear end cap and concentric said coil shaft;
wherein said front end cap is attached to said housing and has a centrally located hole through which said rotor shaft extends; and
wherein rotation of said rotor shaft rotatably displaces said magnets in between said inner coils and outer coils so as to generate electrical energy by magnetic induction.

2. The electric generator of claim 1 that further comprises a gear box attached to said rotor shaft and having a generator shaft that can be rotated to induce the rotation of said rotor shaft at a greater rate of rotation.

3. The electric generator of claim 1 that further comprises a bearing plate placed within said rear end cap, having a plurality of bearings against which said rotor cylinder rests so as to facilitate rotation of said rotor shaft.

4. The electric generator of claim 1 that further comprises a plurality of fan blades attached to said rotor cylinder so as to induce air flow within said shell as said rotor cylinder rotates.

5. The electric generator of claim 1 further comprising a plurality of heat fins attached to said shell such that heat within said shell is dissipated.

6. The electric generator of claim 1 further comprising a plurality of venting holes throughout said shell and said rotor cylinder such that air flow is facilitated within said housing.

7. The electric generator of claim 1 further comprising a plurality of fins attached to an outer surface of said housing so as to induce heat dissipation and promote structural rigidity.

8. An electric generator that comprises:
a housing attached to a base;
a rear end cap;
a plurality of outer coils attached to a coils shaft that is centrally attached to said rear end cap;
a plurality of inner coils attached to an inner surface of said housing that is attached to said rear end cap and concentric to said coil shaft;
a plurality of magnets attached to a rotor cylinder that is rotatably placed between said housing and said coil shaft; and
wherein rotation of said rotor cylinder rotatably displaces said magnets in between said inner coils and outer coils so at to generate electrical energy by magnetic induction.

9. The electric generator of claim 8 that further comprises a gear box attached to said rotor cylinder and having a generator shaft that can be rotated to induce the rotation of said rotor cylinder at a greater rate of rotation.

10. The electric generator of claim 8 that further comprises a bearing plate placed within said rear end cap, having a plurality of bearings against which said rotor cylinder rests so as to facilitate rotation.

11. The electric generator of claim 8 that further comprises a plurality of fan blades attached to said rotor cylinder so as to induce air flow within said housing as said rotor cylinder rotates.

12. The electric generator of claim 8 that further comprises a plurality of venting holes throughout said rotor cylinder such that air flow is facilitated within said housing.

13. The electric generator of claim 8 further comprising a plurality of fins attached to an outer surface of said housing so as to induce heat dissipation and promote structural rigidity.

14. An electric generator comprising:
a plurality of outer coils attached to a coil shaft that is centrally attached to a rear end cap;
a plurality of inner coils attached to a housing that is attached to said rear end cap and concentric to said coil shaft;
a plurality of magnets attached to a rotor cylinder that is rotatably placed between said housing and said coil shaft; and
wherein rotation of said rotor cylinder displaces said magnets in between said inner coils and outer coils so as to generate electrical energy.

15. The electric generator of claim 14 that further comprises a gear box attached to said rotor cylinder and having a generator shaft that can be rotated to induce the rotation of said rotor cylinder at a greater rate of rotation.

16. The electric generator of claim 14 that further comprises a bearing plate placed within said rear end cap, having a plurality of bearings against which said rotor cylinder rests so as to facilitate rotation.

17. The electric generator of claim 14 that further comprises a plurality of fan blades attached to said rotor cylinder so as to induce air flow within said housing as said rotor cylinder rotates.

18. The electric generator of claim 14 that further comprises a plurality of venting holes throughout said rotor cylinder such that air flow is facilitated within said housing.

19. The electric generator of claim 14 further comprising a plurality of fins attached to an outer surface of said housing so as to induce heat dissipation and promote structural rigidity.
